(19) United States
(12) Patent Application Publication
(10) Pub. No.: US 2004/0147686 A1
(43) Pub. Date: Jul. 29, 2004

(54) Process for preparing hydrogenated conjugated diene block copolymers

(75) Inventor: Kimberly A. Johnson, Richmond, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 10/741,532

(22) Filed: Dec. 19, 2003

Related U.S. Application Data
(60) Provisional application No. 60/437,718, filed on Dec. 31, 2002.

(51) Int. Cl. C08F 136/00

(52) U.S. Cl. 525/331.9; 525/333.3; 525/360

(57) ABSTRACT

Disclosed is a process for preparing hydrogenated conjugated diene block copolymers having the steps of (a) charging a solvent, a microstructure control agent, and an alkenyl aromatic hydrocarbon monomer into a first reactor forming an admixture of solvent, a microstructure control agent, and an alkenyl aromatic hydrocarbon monomer wherein the concentration of the microstructure control agent is from about 5 to about 10 weight percent; (b) titrating the admixture of solvent, microstructure control agent, and alkenyl aromatic monomer using an anionic polymerization initiator to form a living polymer; (c) allowing sufficient time for the living polymer to react with and incorporate the alkenyl aromatic monomer; (d) charging a conjugated diene monomer into the first reactor; (e) allowing sufficient time for the living polymer to react with and incorporate the conjugated diene monomer to form a living block copolymer; and (f) hydrogenating the living block copolymer to form a hydrogenated conjugated diene block copolymer. This single reactor process allows for the use of a microstructure control agent.

### CROSS REFERENCE TO RELATED APPLICATIONS

This application claims priority to Provsional Patent Application having Serial No. 60/437,718 filed Dec. 31, 2002.

### BACKGROUND OF THE INVENTION

1. Field of the Invention

This invention relates to a process for preparing conjugated diene block copolymers. This invention particularly relates to preparing hydrogenated conjugated diene block copolymers.

2. Background of the Art

Unsaturated conjugated diene block copolymers are hydrogenated for a variety of reasons. The presence of olefinic double bonds in the polymers makes them susceptible to oxygen attack and to deterioration by actinic radiation; saturation of olefinic double bonds greatly improves environmental stability and may improve color. For example, U.S. Pat. No. 3,130,237, suggests hydrogenating unsaturated compounds by the use of certain cobalt complexes. It is also known to hydrogenate polymers using the more common nickel catalysts.

In a synthetic process for making such hydrogenated copolymers, an initiator compound is used to start the polymerization of one monomer, often styrene. The reaction is allowed to proceed until all of the monomer is consumed resulting in a living homopolymer. To this living homopolymer is added a second monomer that is chemically different from the first, often butadiene. The living end of the first polymer serves as the site for continued polymerization, thereby incorporating the second monomer as a distinct block into the linear polymer. The block polymer so grown is living until terminated. After the polymer is prepared, it is then hydrogenated thereby removing some or even all of the unsaturation from the polymer. The polymers so prepared can be diblocks such as the styrene-butadiene diblock described above or even triblocks wherein additional styrene is added after the butadiene is polymerized.

Microstructure control of the conjugated diene polymers can be important because a controlled degree of branching in the butadiene block of the copolymer can be desirable. This is particularly true in the case of polymers that are hydrogenated. For example, in the case of butadiene, if the polybutadiene or polybutadiene block is all straight chain, such as in 1,4-polybutadiene, then when the polymer is hydrogenated it will have a polyethylene-like structure and have the corresponding crystallinity associated with such a structure. If the polybutadiene or polybutadiene block is branched, such as in 1,2-polybutadiene, the crystallinity will be lessened or eliminated, which can introduce thermoplastic and elastomeric properties into the polymer. U.S. Reissue Patent RE27145 discloses use of microstructure control agents in the preparation of block copolymers.

It is desirable that the microstructure of the block copolymer includes at least some degree of branching or vinyl content in the polybutadiene midblocks, particularly for thermoplastics. The resulting block copolymers can then have the desired thermoplastic and elastomeric properties, such as lower glass transition temperature, usually designated using the symbol Tg, and hardness.

This is known in the art and it is disclosed in references such as U.S. Pat. No. 5,795,944 to Graafland, et al. Therein, it is disclosed to use a microstructure control agent in two or more doses to closely control the vinyl content of a polymer, in some case even varying the vinyl content within different regions within the midblock.

It would be desirable in the art of preparing hydrogenated conjugated diene block copolymers to prepare the polymers using a single reactor. It would be particularly desirable to prepare such polymers using a single reactor wherein the polymer is prepared including a microstructure control agent.

### SUMMARY OF THE INVENTION

An aspect of the present invention is a process for preparing a hydrogenated conjugated diene block copolymer comprising the steps of: (a) charging a solvent, a microstructure control agent, and an alkenyl aromatic hydrocarbon monomer into a first reactor forming an admixture of solvent, a microstructure control agent, and an alkenyl aromatic hydrocarbon monomer wherein the concentration of the microstructure control agent is from about 5 to about 10 weight percent; (b) titrating the admixture of solvent, microstructure control agent, and alkenyl aromatic monomer using an anionic polymerization initiator to purify the admixture prior to initiating the polymerization and charge the desired quantity of anionic polymerization initiator to form a living polymer; (c) allowing sufficient time for the living polymer to react with and incorporate the alkenyl aromatic monomer; (d) charging a conjugated diene monomer into the first reactor; (e) allowing sufficient time for the living polymer to react with and incorporate the conjugated diene monomer to form a living block copolymer; and (f) hydrogenating the living block copolymer to form a hydrogenated conjugated diene block copolymer using a cobalt hydrogenation catalyst.

### BRIEF DESCRIPTION OF THE DRAWINGS

For a detailed understanding and better appreciation of the present invention, reference should be made to the following detailed description of the invention and the preferred embodiments, taken in conjunction with the accompanying drawings, wherein:

FIG. 1 is a graphical representation of the affect on polymerization rates of diethyl ether concentration; and

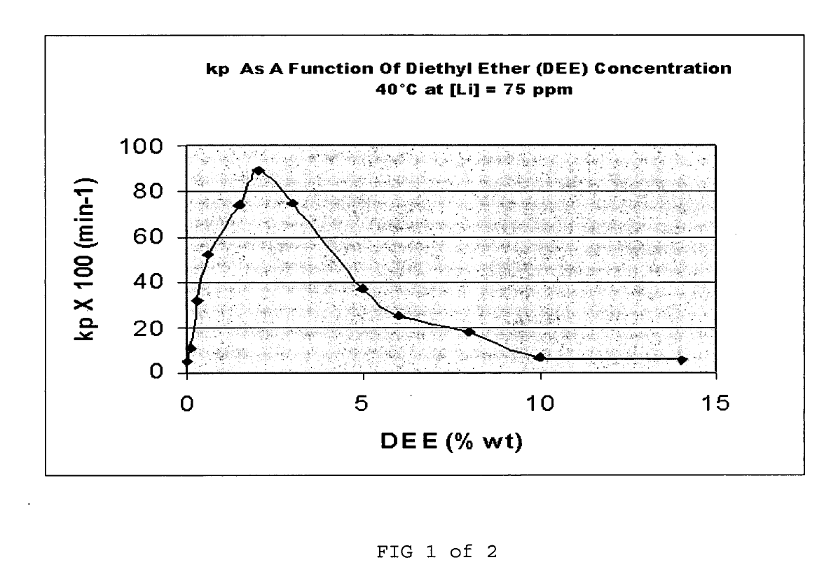

FIG. 2 is a graphical representation of a one of several runs from which the data in FIG. 1 was calculated

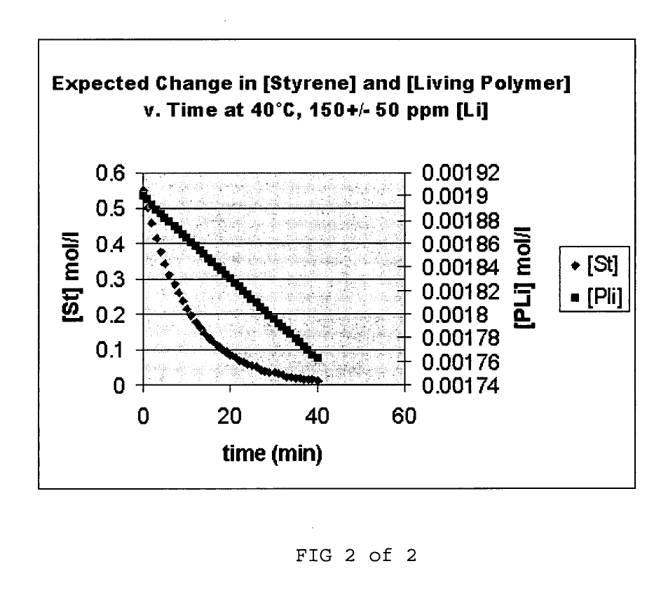

### DETAILED DESCRIPTION OF THE PREFERRED EMBODIMENTS

In one embodiment, the present invention is a process for a hydrogenated conjugated diene block copolymer, the process including a step of charging a solvent, a microstructure control agent, and an alkenyl aromatic hydrocarbon monomer into a first reactor forming an admixture of solvent, a microstructure control agent, and an alkenyl aromatic hydrocarbon monomer. Suitable solvents include straight and branched chain hydrocarbons such as pentane, hexane, octane and the like, as well as alkyl-substituted derivatives thereof; cycloaliphatic hydrocarbons such as cyclopentane, cyclohexane, cycloheptane and the like, as well as alkyl-substituted derivatives thereof; aromatic and alkyl-substituted derivatives thereof; aromatic and alkyl-substituted aromatic hydrocarbons such as benzene, naphthalene, toluene, xylene and the like; hydrogenated aromatic hydrocarbons such as tetralin, decalin and the like; and mixtures thereof. These or any other solvents known to those of ordinary skill in the art of preparing hydrogenated block copolymers can be used with the present invention.

In the practice of the process of the present invention for polymerizing a conjugated diene, a microstructure control agent is added to the living polymer admixture. For the purposes of the present invention, the term “living polymer” means that the polymerization site on the polymer is active and the polymer is capable of continuing chain propagation when in contact with a suitable monomer. The desired level of vinyl content is achieved by properly selecting the type and the amount of these microstructure control agents, which are commonly Lewis basic compounds. Such compounds include ether compounds and tertiary amines. Examples of these microstructure control agents include cyclic ethers such as tetrahydrofuran, tetrahydropyran and 1,4-dioxane; aliphatic monoethers such as diethyl ether, dimethyl ether and dibutyl ether; aliphatic polyethers such as ethylene glycol dimethyl ether, ethylene glycol diethyl ether, ethylene glycol dibutyl ether, diethylene glycol diethyl ether and diethylene glycol dibutyl ether; 1,2-diethoxy propane; aromatic ethers such as diphenyl ether, o-dimethoxy benzene, and anisole; tertiary amine compounds such as triethyl amine, tipropyl amine, tributyl amine; and other compounds such as N,N,N′,N′-tetramethylethylene diamine, N,N-diethyl aniline, pyridine and quinoline.

Many of these microstructure control agents are temperature sensitive, producing varying amounts of vinyl content in the diene polymer at different temperatures. Thus, if a constant vinyl content is required in the polymer, the polymerization must be carried out isothermally. Diethyl ether is often used because it is not as temperature sensitive as the others and does not require isothermal operation. For the purposes of the present invention, the preferred microstructure control agent is an aliphatic ether. More preferably the microstructure control agent is selected from the group consisting of tetrahydrofuran, tetrahydropyran and 1,4-dioxane; aliphatic monoethers such as diethyl ether, dimethyl ether, dibutyl ether and mixtures thereof. Most preferably, the microstructure control agent is diethyl ether.

The alkenyl aromatic hydrocarbon monomers useful with the present invention include vinyl aryl compounds such as styrene, various alkyl-substituted styrenes, alkoxy-substituted styrenes, α-methyl styrene2-vinyl pyridine, 4-vinyl pyridine, vinyl naphthalene, alkyl-substituted vinyl naphthalenes and the like. Mixtures of these may be used. Any alkenyl aromatic hydrocarbon monomer known to those of ordinary skill in the art of preparing hydrogenated conjugated diene block copolymers to be useful can be used with the present invention.

In the process of the present invention, the admixture of solvent, microstructure control agent, and alkenyl aromatic monomer is titrated using an anionic polymerization initiator to react away impurities prior to initiating the polymerization reaction. The conjugated diene block copolymers of the present invention are prepared using solution anionic polymerization techniques. Using this process, the block copolymers of the present invention are prepared by contacting the monomer or monomers to be polymerized simultaneously or sequentially with an anionic polymerization initiator such as group IA metals, their alkyls, amides, silanolates, naphthalides, biphenyls or anthracenyl derivatives. It is preferred to use an organo alkali metal, such as a lithium or sodium or potassium compound, in a suitable solvent at a temperature within the range from about 10° C. to about 150° C., preferably at a temperature within the range from about 30° C. to about 120° C. Particularly effective anionic polymerization initiators are organo lithium compounds having the general formula:

RLiⁿ

wherein R is an aliphatic, cycloaliphatic, aromatic or alkyl-substituted aromatic hydrocarbon radical having from 1 to about 20 carbon atoms and n is an integer of 1 to 4. The organolithium initiators are preferred for polymerization at higher temperatures because of their increased stability at elevated temperatures.

While the monofunctional initiators are preferred for use with the present invention, other multifunctional initiators, particularly as minor amounts in admixture with monofunctional initiators can be used. There are many multifunctional initiators that can be used herein. The di-sec-butyl lithium adduct of m-diisopropenyl benzene is preferred because of the relatively low cost of the reagents involved and the relative ease of preparation. Diphenyl ethylene, styrene, butadiene, and isoprene will all work to form dilithium (or disodium) initiators upon contact with the zero valence metal. Still another compound that will form a di-initiator with an organo alkali metal such as lithium and will work in the process of the present invention is the adduct derived from the reaction of 1,3-bis(1-phenylethenyl)benzene (DDPE) with two equivalents of a lithium alkyl.

Related adducts which are also known to give effective dilithium initiators are derived from the 1,4-isomer of DDPE. In a similar way, it is known to make analogs of the DDPE species having alkyl substituents on the aromatic rings to enhance solubility of the lithium adducts. Related families of products which also make good dilithium initiators are derived from bis[4-(1-phenylethenyl)phenyl]ether, 4,4′-bis(1-phenylethenyl)-1,1′-biphenyl, and 2,2′-bis[4-(1-phenylethenyl)phenyl]propane. For example, see L. H. Tung and G. Y. S. Lo, Macromolecules, 1994, 27, 1680-1684 (1994) and U.S. Pat. Nos. 4,172,100, 4,196,154, 4,182,818, and 4,196,153. Suitable lithium alkyls for making these dilithium initiators include the commercially available reagents, such as sec-butyl and n-butyl lithium, as well as anionic prepolymers of these reagents, polystyryl lithium, polybutadienyl lithium, polyisopreneyl lithium, and the like.

For the practice of the process of the present invention, the anionic polymerization initiator is preferably selected from the group consisting of sec-butyl lithium, n-butyl lithium, polystyryl lithium, polybutadienyl lithium, polyisopreneyl lithium, and mixtures thereof. More preferably, the anionic polymerization initiator is preferably selected from the group consisting of sec-butyl lithium, n-butyl lithium, and mixtures thereof. Most preferably, the anionic polymerization initiator is sec-butyl lithium.

In the practice of the present invention, the anionic polymerization initiator is used to titrate the admixture of solvent, microstructure control agent, and alkenyl aromatic monomer. For the purposes of the present invention, the term titrate means the practice of adding an anionic polymerization initiator incrementally to first consume the impurities in the reactants and then a sufficient amount of initiator to support the polymerization process. The reactants useful for practicing the process of the present invention can have impurities that would either prevent the polymerization of the monomers from occurring or cause a premature chain termination. These impurities, chiefly water, are most economically removed using the initiator to react them away.

After the initiator is added to the reactor, sufficient time for the living polymer to react with and incorporate the alkenyl aromatic monomer is allowed to pass. The purpose of this step is that preferably, the block copolymers of the present invention contain clean blocks of each polymer type. In block copolymers prepared using two monomers, A and B, each block should contain predominantly only one component, A or B. In each block, the presence of the non-predominant or minor component is preferably less than 5 weight percent, more preferably less than 2 weight percent. Most preferably each block contains only one or essentially only one component, i.e. A or B.

In the process of the present invention, the process is continued by charging a conjugated diene monomer into the first reactor. Conjugated dienes that are useful with the present invention and which can be polymerized anionically include those conjugated diolefins containing from 4 to about 12 carbon atoms such as 1,3-butadiene, isoprene, piperylene, methylpentadiene, 1,3-cyclohexadiene, 1,3-cylcohepatdiene, 1,3-cyclooctadiene, phenylbutadiene, 3,4-dimethyl-1,3-hexadiene, 4,5-diethyl-1,3-octadiene and the like. Conjugated diolefins containing from 4 to about 8 carbon atoms are preferred for use in such polymers. Most preferably, the conjugated diolefin is 1,3-butadiene.

In the practice of the present invention, after the conjugated diolefin is charged to the first reactor, sufficient time for the living polymer to react with and incorporate the conjugated diene monomer to form a living block copolymer is allowed to pass. The time for both this step and the earlier step of allowing a first monomer to react is a function of the monomers selected and the reaction conditions.

The process of the present invention can be used to prepare diblock copolymers, but preferably the process is used to prepare triblock copolymers. In the triblock process, after the addition of the conjugated diene and polymerization thereof, a third monomer, often identical to the first is then added to the reactor. This triblock is often composed of styrene endblocks around a butadiene or isoprene midblock. In an alternative process, triblocks can be prepared by coupling diblocks. Such coupling is known in the art and is typically done using a dialkoxy silane coupling agent. Preferably, the present invention is practiced using a dimethoxy coupling agent but any such coupling agent known to those of ordinary skill in the art to be useful can be used with the present invention.

After the backbone of the block copolymer is essentially complete, the living block copolymer can be terminated and hydrogenated. In a termination step, the living polymer is admixed with a material that will render the polymerization site on the living polymer inactive. For example, the use of methanol as a termination agent is known and disclosed in U.S. Pat. No. 6,492,469 to Willis, et al. Any termination agent known to be useful to those of ordinary skill in preparing block copolymers to terminate living polymers can be used with the present invention. In most instances it is desirable to terminate the living polymers as living polymers can sometimes interfere with hydrogenation catalysts.

In the practice of the present invention, the conjugated diene copolymers are hydrogenated. In one embodiment of the process of the present invention, this hydrogenation occurs in the same reactor as the polymerization steps. In another embodiment, the conjugated diene copolymer is moved into a separate and specialized reactor wherein the hydrogenation step occurs. Either method can be practiced with the process of the present invention.

In general, the hydrogenation of the block copolymers may be accomplished using any of the several hydrogenation processes known in the prior art. For example the hydrogenation may be accomplished using methods such as those taught, for example, in U.S. Pat. Nos. 3,494,942; 3,634,594; 3,670,054; 3, 700,633; and U.S. Pat. No. Re. 27,145, the disclosure of which patents are incorporated herein by reference. The methods known in the prior art and useful in the present invention for hydrogenating polymers containing ethylenic unsaturation and for hydrogenating or selectively hydrogenating polymers containing aromatic and ethylenic unsaturation, involve the use of a suitable catalyst, particularly a catalyst or catalyst precursor comprising an iron group metal atom, particularly nickel or cobalt, and a suitable reducing agent such as an aluminum alkyl.

The hydrogenation may be carried out with a hydrogen partial pressure of between 0.1 and 10 MPa. More typically, the hydrogen partial pressure is between 0.7 and 8.3 MPa. The amount of hydrogenation catalyst may vary from 0.001 to 10 g per kg polymer. Hydrogenation can be carried out at temperatures of between 25° C. and 100° C. The time of hydrogenation under such conditions will typically be between 0.1 and 4 hours, achieving greater than 90 percent hydrogenation of the initial olefinic unsaturation.

After hydrogenation, it may be necessary for product quality purposes, to remove the catalyst residues. This can be accomplished by any of the methods of the art. Typically, the hydrogenation solution is contacted with a dilute aqueous acid under oxidizing conditions to oxidize and extract the hydrogenation catalyst residues into the aqueous phase. This phase is then separated from the polymer phase by decantation.

The hydrogenated polymer is typically stabilized by the addition of an antioxidant or mixture of antioxidants. Frequently, a phosphorus-based stabilizer is used in combination with a sterically hindered phenolic stabilizer, such as disclosed in Japanese patent No. 94055772; or a combination of phenolic stabilizers is used, such as disclosed in Japanese patent No. 94078376.

Finally, the hydrogenated polymer may be isolated and recovered by a variety of techniques. The polymer may be isolated in the form of crumbs, using the technology disclosed in U.S. Pat. No. 3,202,647 or disclosed in EP patent Appl. No.731,111; by use of a cyclone separator as disclosed in U.S. Pat. No. 3,804,15 and 3,968,003; or by use of a devolatilizing extruder (vented extruder) as is disclosed for instance in Japanese patent No. 91049281.

In the practice of the process of the present invention, the microstructure control agent is present in a concentration such that the rate of polymer chain propagation substantially exceeds the rate of chain die-out. As with many other polymerization reactions, the block copolymers produced in the practice of the present invention are not of a uniform molecular weight and composition. While not wishing to be bound by any theory, it is commonly believed that during the polymerization step, there is a competition between the reaction to build molecular weight and side reactions that terminate polymerizations. For example, any reaction that deactivates or kills a living polymer would cause chain die-out. Under preferred conditions, the rate of propagation is substantially faster than chain die-out such that die-out is minimized.

Microstructure control agents can cause an acceleration of chain die-out. For example, one result of having too much diethyl ether in the first step of the process of the present invention would be an undesirable acceleration in chain die-out resulting in the excess production of homopolymers, such as homopolystyrene. Therefore, in the practice of the present invention, it is necessary to use a concentration of microstructure control agent that is sufficiently high to impart the desired amount of vinyl content in the conjugated diene block, but also sufficiently low to allow for sufficient chain growth.

When the microstructure control agent is diethyl ether, it has been surprisingly discovered that the optimum concentration of diethyl ether in the first step of the reaction is from about 5 to about 10, preferably about 7 to about 9 weight percent. When the amount of diethyl ether is less than this level, the reaction can be too fast and therefore difficult to control and the desired amount of vinyl content in the conjugated diene block may not be achievable. When the diethyl ether content is higher than this level, then the polymerization reaction can be too slow relative to the rate of chain die-out and result in a copolymer having too much homopolymer content and a too high molecular weight.

The process of the present invention is a major improvement over conventional processes using two reactors for the polymerization of the copolymer. One advantage is a reduction in the cost of capital equipment. A second advantage is the reduction in the movement of the living polymer from a first reactor to second reactor thereby eliminating the possibility of mixing of incompatible chemicals and chemical spills. Still another advantage is the rate enhancement observed in the rate of polymerization of the step I styrene. This step, when unmodified, typically takes 40-50 minutes. Under the conditions of the present invention, this reaction time is reduced to typically 5-15 minutes.

### EXAMPLES AND COMPARATIVE EXAMPLES

The following examples are provided to illustrate the present invention. The examples are not intended to limit the scope of the present invention and they should not be so interpreted. Amounts are in weight parts or weight percentages unless otherwise indicated.

### Example 1

8% Diethyl Ether

A vessel is charged with 123 kg cyclohexane, 6.1 kg styrene and 11.2 kg diethyl ether (DEE) (8% wt). The solution is titrated and then initiated with 113 ppm Li (as sec-butyl lithium). The reaction propagates at an average temperature of 48° C. and is complete (8 half-lives) in 11.2 minutes. 27.8 kg butadiene is added and allowed to react to completion. 6.1 kg styrene is added to form the third block and complete the polymer. A GPC determination of molecular weight (MW) using a polystyrene standard is made. The data shows that the step I polymer has a styrene equivalent MW of 29260, the step II polymer has a styrene equivalent MW of 286200 and the step III polymer has a styrene equivalent MW of 325200. There is 0.59% wt of homopolystyrene in the step III analysis.

### Comparative Example I

14% Diethyl Ether

A vessel is charged with cyclohexane, styrene (0.55 mol/1) and DEE (14% wt). The solution is titrated and then initiated with 150 ppm Li (as sec-butyl lithium). The rate of styrene loss and polymer formation are monitored by in-situ infrared spectroscopy. The rate of polymer-Li (PLi) loss is monitored by in-situ UV-VIS spectroscopy. It is observed that at 98% conversion of the styrene monomer, approximately 7% of the polymer chains are lost to die-off.

What is claimed is:

1. A process for preparing a hydrogenated conjugated diene block copolymer comprising the steps of:
(a) charging a solvent, a microstructure control agent, and an alkenyl aromatic hydrocarbon monomer into a first reactor forming an admixture of solvent, a microstructure control agent, and an alkenyl aromatic hydrocarbon monomer wherein the concentration of the microstructure control agent is from about 5 to about 10 weight percent;
(b) titrating the admixture of solvent, microstructure control agent, and alkenyl aromatic monomer using an anionic polymerization initiator to form a living polymer;
(c) allowing sufficient time for the living polymer to react with and incorporate the alkenyl aromatic monomer;
(d) charging a conjugated diene monomer into the first reactor;
(e) allowing sufficient time for the living polymer to react with and incorporate the conjugated diene monomer to form a living block copolymer; and
(f) hydrogenating the living block copolymer to form a hydrogenated conjugated diene block copolymer using a cobalt hydrogenation catalyst.

2. The process of claim 1 wherein the microstructure control agent is present in a concentration such that the rate of polymer chain propagation substantially exceeds the rate of chain die-out.

3. The process of claim 2 wherein the microstructure control agent is diethyl ether.

4. The process of claim 3 wherein the diethyl ether is present in step (a) at a concentration of from about 6 to about 9 percent.

5. The process of claim 4 wherein the diethyl ether is present in step (a) at a concentration of about 8 percent.

6. The process of claim 2 further comprising a step (e-1) wherein after step (e) but prior to step (f) the living block copolymer is terminated.

7. The process of claim 6 wherein the termination is accomplished using methanol as a termination agent.

8. The process of claim 6 wherein step (f) occurs in the first reactor.

9. The process of claim 6 additionally comprising step (e-2) wherein after step (e-1) but prior to step (f), the terminated block copolymer is transferred to a second reactor.

10. The process of claim 2 additionally comprising a steps (e-I) and (e-II) that occur after step (e) but prior to step (f) wherein in step (e-I) an alkenyl aromatic hydrocarbon monomer is charged to the first reactor and in step (e-II) sufficient time for the living polymer to react with and incorporate the alkenyl aromatic monomer is allowed to pass.

11. The process of claim 2 wherein the alkenyl aromatic hydrocarbon is styrene.

12. The process of claim 11 wherein the conjugated diene monomer is butadiene.

13. The process of claim 12 wherein the block copolymer is a triblock having a structure of styrene-butadiene-styrene.

14. The process of claim 12 wherein the anionic polymerization initiator is sec-butyl lithium.

15. The process of claim 2 additionally comprising step E1 wherein Step E1 is addition of a coupling agent.
